(19) United States
(12) Patent Application Publication
(10) Pub. No.: US 2016/0079834 A1
(43) Pub. Date: Mar. 17, 2016

(54) Low-maintenance cogless electric generator featuring magnetic levitation

(71) Applicants: Jay Moskowitz, Boynton Beach, FL (US); Robert Perless, Greenwich, CT (US); Steven J. Hansel, Parker, CO (US)

(72) Inventors: Jay Moskowitz, Boynton Beach, FL (US); Robert Perless, Greenwich, CT (US); Steven J. Hansel, Parker, CO (US)

(21) Appl. No.: 14/855,797

(22) Filed: Sep. 16, 2015

Related U.S. Application Data
(60) Provisional application No. 62/050,935, filed on Sep. 16, 2014.

(51) Int. Cl. H02K 15/04; H02K 1/27; H02K 3/28; H02K 7/09; H02K 9/22; H02K 9/02; H02K 9/00; H02K 3/30; H02K 7/08

(52) U.S. Cl. CPC H02K 15/0435; H02K 3/30; H02K 1/27; H02K 3/28; H02K 7/08; H02K 9/22; H02K 9/02; H02K 9/005; H02K 7/09

(57) ABSTRACT

A cogless electric generator consisting of a compressed nearly all copper air core stator placed within a surrounding rotor containing a plurality of permanent magnets is described which is particularly suitable for direct-drive integration with small-wind turbines. Such turbines become capable of generating electric energy at very low wind speeds. A particular focus is in reducing maintenance and operational costs of such a device by eliminating magnetic attraction of internal components typical of such generators and by reducing friction on bearings through the use of magnetic levitation. Techniques are employed to reduce eddy currents to increase the efficiency of the generator. Air scoops and air flow considerations combined with convective elements intimately in contact with and extending through the stator, allow heat directly from the stator to be dissipated externally. When the generator is assembled and disassembled for service, there is no magnetic attraction or repulsion that would otherwise make such service difficult, dangerous or require special handling tools.

This application claims the benefit of U.S. Provisional Application No. 62/050,935, filed Sep. 16, 2014, which is incorporated herein by reference for all purposes.

This invention pertains to an electric generator consisting of a non-metallic stator and a rotor containing a plurality of permanent magnets that is capable of starting to generate electricity with the application of a minimal amount of torque to the rotor because of the elimination of magnetic attraction between elements of the stator and rotor as well as reduced friction in the turning of the rotor through the application of magnetic levitation. This non-cogging invention lends itself to the creation of large diameter generators that create greater speeds of magnets across dense stator coils at relatively low RPMs thereby generating high power levels while eliminating complex gearing systems found in large scale turbines, the energy losses inherent in them and the excessive maintenance costs associated with such systems.

### BACKGROUND

Wind energy is renewable, clean, widely distributed and does not emit greenhouse gases during operation. It has been growing at an average rate of 25% per year, making wind the fastest growing source of energy in the world since 1990. Wind power provides a range of advantages such as 1) being friendly to the surrounding environment, as no fossil fuels are burnt to generate electricity from wind energy, 2) they take up less space than the average power station, 3) Wind is a free source of energy nearly 24 hours a day, 7 days a week, and 4) Wind turbines are a great resource to generate energy in remote locations, such as mountain communities, remote country sides, islands where it is very costly to import fossil fuels and in developing countries to provide a steady, reliable supply of electricity.

Small wind turbines are electric generators that utilize wind energy to produce clean, emission-free power for individual homes, farms, small businesses, schools, remote telecommunication sites and on marine vehicles. With this simple and increasingly popular technology, individuals, businesses and communities can generate their own power and cut their energy bills while helping to protect the environment. Small wind is defined as having rated capacities of 100 kilowatts and less, and the market is expected to continue strong growth through the next decade. Their larger counterparts, capable of generating megawatts of electricity, are typically located in rural and off-shore environments because of certain disadvantages which require these to be placed away from locations where people are living. These large turbines require that their generated electricity be transported tens or hundreds of miles away to where it is to be utilized. Small wind turbines are typically located at the point where the electricity will be used. They can easily lower electric bills by 50%-90%.

These small wind turbines typically rotate at higher speeds than their larger counterparts and utilize direct drive generators as opposed to complex gearing systems to drive generators at the speeds required to create more significant amounts of power. However, performance and reliability obstacles have hindered greater adoption of small wind turbines. To increase the rate of adoption of such small wind turbines, highly efficient, low cost, extremely low maintenance, quiet, low operating cost electric generators are needed. Such electric generators must address many factors in their design to achieve these goals. Magnetic attraction of the internal components of typical generators lead to the increased difficulty of initial construction, the requirement to use special tools and equipment, and presents a significant safety risk during the assembly process which together lead to increased selling costs. This same attribute increases ongoing maintenance costs if the generator needs to be serviced as specialized equipment must be utilized to dissemble the unit. This same attraction leads to the requirement for higher torques to start generating electricity which requires higher wind speeds just to generate any level of electricity. Friction internal to the components of the turbine will further increase this higher torque requirement to overcome such friction. As physically larger generators are utilized in order to generate higher amounts of energy, this magnetic attraction and friction further increase the amount of torque required. Eddy currents, generated through electric induced into the metal cores about which the coils are wound, must be addressed as these cause opposing magnetic fields to the permanent magnets reducing the efficiency of the generator. These eddy current also create heat levels that could become significant and can limit the duty cycle of the generator through overheating. Many large wind electric generators have employed complex cooling systems to address such heat related problems. Heat is also created in a generator through the electrical resistance of the wire coils that are passing through the rotating magnetic field.

Typically an electric generator consists of an input shaft which is being rotated by a source whose mechanical energy is to be converted into electrical energy. This may be from a wind turbine rotating via wind, water flowing over a turbine, steam pushing a turbine, as well as a host of other means. This shaft is connected to a rotor containing strong permanent magnets. A stationary housing, referred to as a stator, normally surrounds this rotor so as to form a small air gap between the rotor and stator allowing the magnets to spin on one or both side of the stator. The stator houses coils of electrically conductive wire, such as copper, which is wound in circular loops around a magnetically permeable metal, such as steel, soft iron, or ferrite and placed along the circumference of the rotor, standing perpendicular to the rotational direction of the rotor. The rotation of the magnet field of the rotor past the stator coils causes electrical current to flow through the wires of the stator where this current is conducted outside the generator for distribution. The size of the magnets, their strength, their number, the circular dimension of the rotor, the size and shape of the conductive wires and the number of loops wound together are carefully selected to pre-determine the amount of electrical energy that will be created at a given rotational speed of the rotor. Adjustments of these parameters permit generators of different capacities to be created.

But when such a rotor shaft is not moving there is an initial internal resistance due to friction on internal bearings that is coupled with a further resistance formed from the strong electromotive force, EMF, which comes from the magnetic attraction between the permanent magnets and the magnetically permeable material on which the stator wire loops are wound. This force, which must be overcome to initiate electric production, is referred to as cogging torque. Additional torque must be applied from the external mechanical energy before this resistance is overcome. In wind generation equipment, for example, this translates into higher winds that are required before any electrical generation is possible.

This invention is not does not suffer from the issues of a typical generator through the introduction of a different rotor and stator configuration combined with features that significantly reduce the startup speed of such generators. The elimination of cogging in the generator allows small wind turbines that may feed mechanical energy into such generators to immediately be converted to electrical energy and eliminates the potential of stalling or the inability to self-start in low wind situations. Cogging torque in a permanent magnet generator not only affects the self-starting ability, but also produces noise and mechanical vibration which may threaten the integrity of the mechanical structure of an improperly designed small wind turbine.

### SUMMARY OF THE INVENTION

This invention creates a low cost, low torque, low friction, and low maintenance, highly efficient electric generator providing for high duty cycles by addressing each of the main factors that have hampered prior generators.

Unlike a typical generator, the novelty of this disclosed invention is to eliminate the use of magnetically permeable material in the stator by creating a dense set of compressed wires held together in a resin based potting material which removes the magnetic attraction that would otherwise have increased the required rotor torque to overcome. The stator is copper and metallic but non-magnetic. More electrically generating copper exists in such a dense stator since the metallic stator supports of a typical generator are eliminated. In some incarnations of the present invention, frictional resistance against the rotor is further reduced through the use of magnetically levitating the rotor so that a minimum amount of weight is placed on internal bearings over which the rotor rotates. These techniques make this invention a cogless generator capable of producing electrical energy at lower start up speeds, reduced maintenance costs, and lower manufacturing costs in several ways. The reduced weight against internal bearings dramatically increases their lifespan and enables less expensive bearings to be employed.

Magnetic levitation also reduces some heat generation through the reduced friction. The lack of magnetic attraction makes assembly and maintenance of the rotor/stator configuration an easy process as compared to the difficult job associated with strong rotor magnets that immediately attempt to lock themselves against the metal in the stator when a attempting to disassemble a unit, and thereby require special tools and equipment to pull the rotor and stator apart. The elimination of the magnetic attraction reduces labor and equipment costs in first constructing the generator and in servicing it. This lower startup resistance due to eliminated magnetic attraction also minimizes energy which would otherwise be lost as heat. The design incorporates cooling from directed air flow vanes integrated into and in direct contact with the rotor. In other embodiments there may also be an external heat sink mechanism that is embedded into the stator itself to dissipate a larger amount of heat. Further embodiments also incorporate a radiator element intimately connected with the stator to provide additional heat dissipation into the air or through a coolant passing through the radiator element.

The stator of the invention has been designed to have three sets of physically offset coils that are woven into a belt that is then hydraulically compressed and cast with resin in a mold to a very dense and precise circular shape that is vacuum formed to become nearly a solid copper and epoxy stator ring. This method enables more power generating copper to be placed into the same space as a conventional generator. The point where the wire of the first coil enters the belt comes in contact with the point where this same wire is exiting the last coil, when the belt is made into the circular shape similar to a leather clothing belt. This belt is placed onto a circulator stator plate made of aluminum, a composite or another material, so that the belt of coils is sitting perpendicular to the stator plate. This first wire is then entering and exiting the stator at the same position along the ring providing two separate wires which are placed through the stator plate. The second coil loop is slightly offset from the first coil loop and the third coil loop is slightly offset from the second coil loop. Being in close vicinity to each other, three pairs of wires come through the stator plate. These wires will carry three phases of electric current that will be generated when a rotor containing magnets is rotated around this static stator. These wires will typically go to a control unit which might be interfaced to Grid Interface Device to put the resultant AC power onto the electric grid, or the control unit might contain a converter to generate a DC voltage from the generator which might be used to charge a bank of batteries, for example. With the three sets of stators wires coming through the stator plate, as opposed to be internally connected to each other, the invention provides for more flexibility in how the generator will deliver its power. The stator wires may be connected externally to define the particular manner of electrical generation provided. Although there are differences in the resulting output and operation of the generator depending upon how these three wire loops are connected, the flexibility still exists to choose which of several possible wiring configurations is desired. Connecting the end of one loop of wires to the start of the next loop essentially has the stator appear as one long coil. This generally causes vibration in the generator because all of the coils are pulled by the magnets at the same time then let go as they pass from one magnet to the next. This continual increasing and decreasing of magnetic attraction produces the uneven torque that results in that vibration. This wiring approach provides a single phase of alternating current but if you rectify that output it provides a ‘lumpy’ DC output going from 0 to some DC voltage. Keeping them as separate coils provides three phase output that are each 120° apart. This provides much more even torque as while one set of coils is coming off the magnetic attraction another set is started into the magnetic attraction. This output is much nicer to rectify as the DC voltage will be fairly flat with little ripples in the higher and lower voltages of the single coil configuration.

With 3 phase electrical production, there are two common configurations for wiring the 3 coils that are accommodated by the invention. One end of each of the 3 coils can be tied together to a common central point. This is known as a Wye (“Y”) or Star configuration. The coils can also be connected in a Delta configuration whereby each coil is connected to the other two coils in a loop as to make a triangle. In general, a Wye configuration gives 1.73 times the voltage output as a Delta configuration while a Delta configuration gives 1.73 times the current of a Wye configuration. Both produce exactly the same amount of output power. In the case of this instantiation of the invention, the inventor has chosen to produce high voltage and low current and let external electronics, which have far more flexibility and variability, convert it as necessary. But with having these separate pairs of wires exit the generator, fill wiring flexibility is provided.

The stator wires inside the stator are woven into rounded rectangular coils whose height is typically larger than the width of the coil. One or more loops of wire are overlapped into coil. The number of loops and the dimensions of each rectangle are determined before construction based on the amount of electric power that is to be generated given the torque that will be available at the rotor shaft at the typical RPMs that are targeted from the external mechanical energy source.

The power output that the generator can produce is a function of its rotational velocity times the torque (p=rpm*T). To create a lot of power either more RPMs must be generated by the turbine to which the generator is connected, the torque must be increased, or both. As implied by the power output formula, a powerful generator operating at slower RPMs needs a larger torque. When this invention is built for optimum performance for a particular turbine, it is examined what level of speed and torque the turbine is capable of producing, and to create a generator that can generate at least as much power as the turbine can produce and let the control electronics do the matching to the turbine.

The stator is physically connected to the stator plate. Heat conducting rods are placed directly below the stator and through the stator plate in order to direct stator heat out through the stator plate and into the air below the stator. These rods dissipate heat into the air. In some instantiations of the invention, this rod may extended through the stator plate and up into the stator itself where it is potted directly into the stator for better heat transfer down through the stator plate and into the air. This rod may further be of a ‘T’ or other shape to increase the area of the heat absorbing rod against the stator coils to transfer more of the heat from the source of its generation through the stator plate.

The rotor section is a circular shape similar to the stator. It consist of a rotor backplate to which is connected a rotor shaft which will transfer external mechanical energy to the rotor. Connected to the rotor plate are two circular concentric rings which protrude below the stator backplate. The inside surface of the outer circular ring or the outside surface of the inner ring, or both, will contain a set of powerful rectangular shaped permanent magnets that are vertically aligned and equally spaced around the ring. The magnets are placed so that the North South orientation is vertical and alternating around the ring. The circumference of the rings must be evenly divisible by the width of one magnet plus its adjacent air space to the magnet placed next to it. This insures that the North South, South North, sequence is maintained through the entire ring so that two North poles or South poles are never next to each other.

The inner and outer magnetically attractive rings may be made of steel, a composite or other material to make it lighter. When steel rings are used, the magnets adhere tightly to the steel and a special tool is required to precisely place them into their proper position during assembly and to lift them from the steel in order to put them in place. Affixing them in place is important to insure they don't move while the rotor is spinning. Using a mold and casting resin rings allows for precisely shaped rings to be created at a lower cost than precision milling of metal to form the same rings. It also makes for a lighter (thus more easily transportable) generator. The magnetically attractive ring can be cast of steel powder suspended in the epoxy matrix. Each magnet is epoxied or glued in its place around the ring. When the ring is cast from a mold, that mold may also contain individual slots precisely in place where each magnet is installed. Such a mold may be designed to easily accommodate the glue material which will hold the magnets in place.

The inner and outer rings of the rotor including the depth of any magnet placed onto the ring form a slot between them. The width of this slot is slightly larger than the width of the circular stator belt. Precision casting or milling of both the inner and outer stator rings and circular rotor belt insures that the rotor rings fits over the stator belt leaving a uniform size air gap between the entire circumference of the stator and the entire circumference of the rings. The closer the magnets on a ring are to the stator the higher magnet flux will be available as the magnets rotate across the stator and the more power that will be generate. So it is desired to maintain the smallest air gap. Air gaps of thousandths of an inch are easily achievable.

The rotor is suspended on a set of bearings that are placed around the circumference of the stator plate to assist in its rotating around the fixed stator of wire coils. In some embodiments of the invention, a circular magnetic ring is embedded into the inside of the rotor while a similar size magnetic ring is embedded into the stator plate in a symmetrical configuration of permanently fixed opposing magnets having both North or South poles facing one another. The strength of these magnetic rings is selected so that the repulsion of these two rings levitates the rotor so as to minimalize the weight which is pressing down onto the bearings. This not only increases the lifespan of the bearing thus reducing maintenance costs and downtime, but it also eliminates a considerable amount of friction which would have required additional torque to overcome. With the introduction of a magnetically levitated (Maglev) rotor, more mechanical energy may be directed toward the generation of electrical energy instead of being used to overcome friction. In a 40″ diameter maglev based prototype generator built by the inventor, a 200 pound rotor was reduced to only placing 1 pound of force on the bearings.

The magnets in the rotor are put in place so that they are vertically centered on the same vertical center line of the rotor. The height of the magnets is less than the height of the stator coils. This centers the magnetic flux across the vertical sides of the wire loops inside each of the coils and reduces the strength of the magnetic field that passes through the horizontal portion of the wire in the top and bottom of each coil loop. This helps energy generation and reducing some of the eddy currents that oppose the permanent magnetic field. Increasing the cross sectional area of each coil loop also reduces the effect of eddy currents. Since the eddy current losses for a conductor are proportional to the square of the thickness of the wires employed, the wire coils loops can consist of bundles of several strands of individual insulated wires that are wired in parallel so as to be the equivalent of a single wire. But the largest elimination of eddy currents comes from the elimination of a magnetically permeable core around each stator coil loop. Significant eddy currents in such a core would generate a lot of heat in the stator. This invention does not suffer from this significant heat buildup since a dense non-magnetic core potted in resin makes up the stator. Eddy currents are also caused due to the magnetic attraction of the rotor magnetic and the shell of the electric generator. But this invention utilizes a shell made of a composite material which further eliminates this potential for these eddy currents which would result in a loss of power production.

In order to create production level stators at a lower cost yet without the need for precisely milling parts, the stator plate may be created out an epoxy resin or polymer poured into a mold. The base of such a stator produced from such material, also reduces or eliminates any eddy currently which would slow down the rotor that will spin above the stator, as well as reducing the heat buildup. Using molds can maintain consistent high tolerances on the size of the stator in order to insure a tight and constant air gap between the stator windings and the magnets in the rotor. Such a mold can also provide slots for the wire coils to better adhere to the walls of the stator. The rotor may also be created from a resin poured into a mold which also would reduce or eliminate the eddy currents that could occur if the rotor was milled from metal. A rotor cast from a mold could provide slots in the rotor to precisely place each of the magnets around the rotor. A resin rotor would not conduct heat as much as that of other materials that a rotor might be milled from, allowing the generator to run cooler.

Heat buildup in this invention primarily comes from the resistance of the wires in the core against the power being generated in these wires from passing through the magnets at a given RPM. If the thickness of the wire used in the coils of the stator core is oversized for the expected power level generated at the average RPMs of the generator, then the resistance will be proportionally lower against that power level than a thinner wire and less heat will be created in the stator at that RPM. If the heat is not dissipated in the generator, the resistance of the coils will increase as the resistance of copper wires is proportional to its temperature in degrees Kelvin. So as the heat increases, the resistance increases and the generator becomes less efficient. If the generator is built to handle more power than the maximum that it expects to generator, it is more efficient and will generate less heat.

As an example of the heat generation, we can assume the coils have a resistance R which is related to the overall length of the wire through the coil turns and the thickness of the wire. For this example we will use a resistance of 5 ohms and assume the generator is producing 100 volts to charge an 80 volt battery. The current that flows out of the generator (I=V/R) would be (100 volts−80 volts)/R or 4 amps. The heat produced in the coils would be I²R or 16*5=80 watts of heat. This can be cooled using air flow or other means described herein, but can also be reduced by increasing the wire thickness so the overall resistance is lowered so that less heat is created.

The use of both inner ring magnets and outer ring magnets increase the magnetic flux available and will generate higher power. Higher power may also be achieved at a given RPM value, by increasing the diameter of the generator (rotor and stator plates) in order to accommodate more magnets. This same power may be achievable in a generator of a smaller diameter by making the stator coils taller and using taller magnets or aligning smaller vertical oriented magnets above one another to essentially form a taller magnet. These taller magnets will provide more magnetic flux and will increase the available output power from a generator that might not be as tall.

In another embodiment of the invention, the cooling rods that are used to transfer heat through the stator plate and to the outside air, may be eliminated and the stator itself can be created so that the bottom of the coils physically pass through the stator plate itself. With the bottom of the stator exposed to the outside air, air will pass directly across a portion of the stator to cool it. This can be augmented in a similar manner as with the ‘T’ shaped heat conductors that are embedded into the stator during casting by having a similar ‘T’ (or other) shaped heat conductor only inserted into that portion of the stator exposed below the stator plate. The addition of this heat conductor will allow additional heat to be dissipated to the outside air. In other embodiments, a radiator element is attached to the stator plate to further dissipate heat away from the generator assembly. For more active dissipation of the built up heat, a refrigeration unit can be connected to the stator plate. Since it would be desired that the power to drive a refrigeration unit would be far less than the power created by the generator, several low cost refrigeration schemes could be employed. Many simple schemes could be employed to further dissipate some of the heat built up during the electric generation process. Tubes can be placed through the stator plate when it is first cast so that some chilling fluid, including something as simple as air passing over ice being blown through the stator plate or even water from a lake, could be used to remove heat from the stator.

Although magnetic levitation is being used to reduce friction on the bearings which allow the magnets to spin about the rotor coils, there is still some lubrication that is required on the bearings. The reduced friction increases the time between preventative maintenance sessions of the bearing and extends the lifetime of the components. Oil or grease would be applied to the bearing at this preventative maintenance session to insure the little friction still remaining is nearly eliminated.

In another instantiation of the invention, these manual preventative maintenance sessions can be even further reduced by employing a computer controlled lubrication system to the bearings of the generator. The bearings may be fitted with computer chips that can monitor them for wear and tear, misalignment and vibration. Sensors may also be placed in the bearings to monitor to level of lubrication material that is around the bearings. Such sensors can supply information to a control computer which can determine when it is best to release more lubrication into the bearings to reduce friction. An oil flow system could be put in place which injects new lubrication oil or other material into the bearings while the old material circulates through a filter and back for spraying into the bearings in a closed loop system. A pump to actively add lubricating material to the bearings would be under computer control as to only introduce lubrication as needed. The lubrication material filter of such a system could conceivably only need replacement every few years.

### BRIEF DESCRIPTIONS OF DRAWINGS

FIG. 1 is a plan view of the rotor.

FIG. 2A is a view of the North/South pole orientation of a single row of magnets which are aligned along the radial axis of the rotor along a vertical band attached perpendicular to the rotor base.

FIG. 2B is a view of the North/South pole orientation of a double height row of magnets which are aligned along the radial axis of the rotor along a vertical band attached perpendicular to the rotor base.

FIG. 3A is an exploded view of the rotor.

FIG. 3B is an assembled view of the rotor.

FIG. 4 is a plan view of the stator.

FIG. 5A is an exploded view of the stator.

FIG. 5B is an assembled view of the stator.

FIG. 6 is a detailed view of the mechanism which aligns the rotor and stator and allows it to be magnetically levitated.

FIG. 7 is a view of the rotor alignment with the stator.

FIG. 8 is an assembled view of the rotor and stator.

FIG. 9A is a view of the first winding step in creating the stator coils and assembling them into a belt.

FIG. 9B is a view of the second winding step in creating the stator where the wire goes back over the wires placed in step one, FIG. 9A.

FIG. 9C is a view of the third winding step in creating the stator where the wire goes back over the wires placed in step one, FIG. 9A, and results in the start and end of this single wire being next to each other thereby forming what will eventually generate one of the phases of electrical output.

FIG. 9D is the result of executing the three winding steps of FIG. 9A, FIG. 9B and FIG. 9C, with three separate wires that are placed slightly offset on top of each other resulting in stator wires which will eventually generate 3 phase electricity.

FIG. 9E takes the finally wound stator of FIG. 9D and places it so that the last loop of wires are co-located with the first loop of three pairs of wires, one from each set of loops, in order to create a ring shaped belt.

FIG. 10 shows the interweaving of the wires associated with each of the three phases of output into each other and into a belt.

FIG. 11 is a view of the rigging used to wire the stator coils.

FIG. 12 is a view of the shape of each of the long and short winding pegs of FIG. 11 from the top of a peg to the bottom.

FIG. 13 is a view of the heat sink which is in contact with the stator and goes through the stator base plate and out to the air below the stator to dissipate heat.

FIG. 14 is a view of a heat sink embedded in the stator to move heat into the air below the stator.

FIG. 15 is a view of an embodiment of the invention where a portion of the heat sink extended into and becomes part of the stator where its direct contact within the stator allows additional heat to be transferred out of the stator and eventually through the base plate and into the air.

FIG. 16 is a view of the alternate stator heat exchange element running through the stator face plate.

FIG. 17 is a view of the stator heat exchange element embedded into the stator.

FIG. 18 is a view of the stator plate with additional heat sinks placed around the base and in contact with the warm air between the rotor and the stator.

FIG. 19 is a view of the generator showing air scoops which helps circulate air through the generator.

FIG. 20A is a view of the air flow through an embodiment of the invention.

FIG. 20B is a view of the air flow through a second embodiment of the invention.

FIG. 21 is a view of the existing radial orientation of the stator and rotor of this embodiment on the rightmost side of the diagram while the leftmost side shows an alternative axial orientation of a stator.

FIG. 22 is a graph showing how the power of the generator increases when the number of magnets and coils are doubled. The amount of additional power is based on the efficiency of the generator as shown by the various power curves.

FIG. 23 is a front cross-sectional view of the rotor and stator and the air gap between them in the prototype large diameter generator that was constructed

### DESCRIPTION OF ILLUSTRATIVE EMBODIMENTS

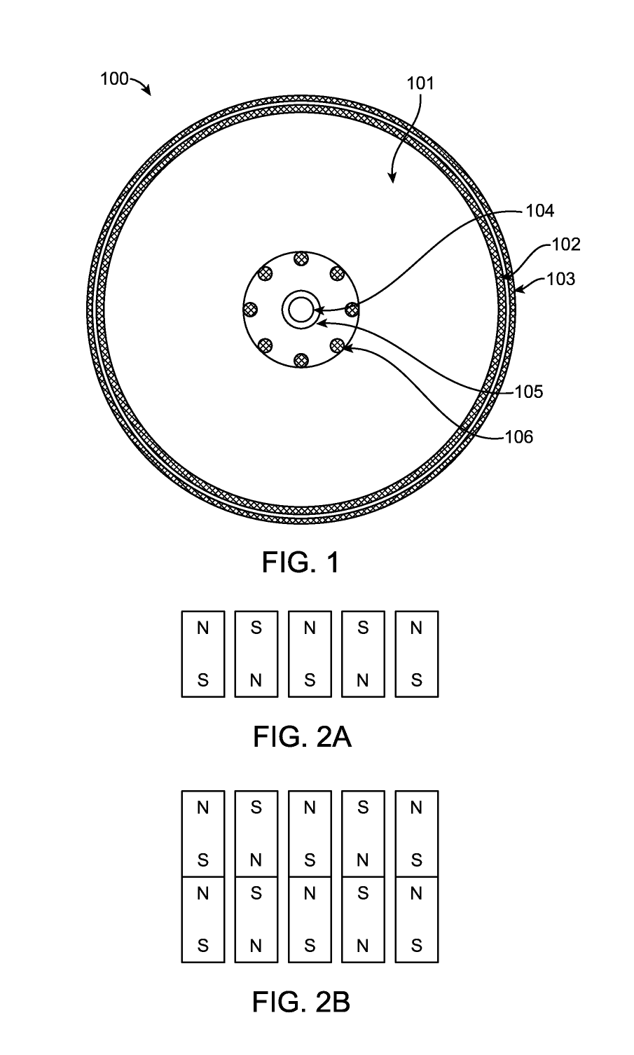

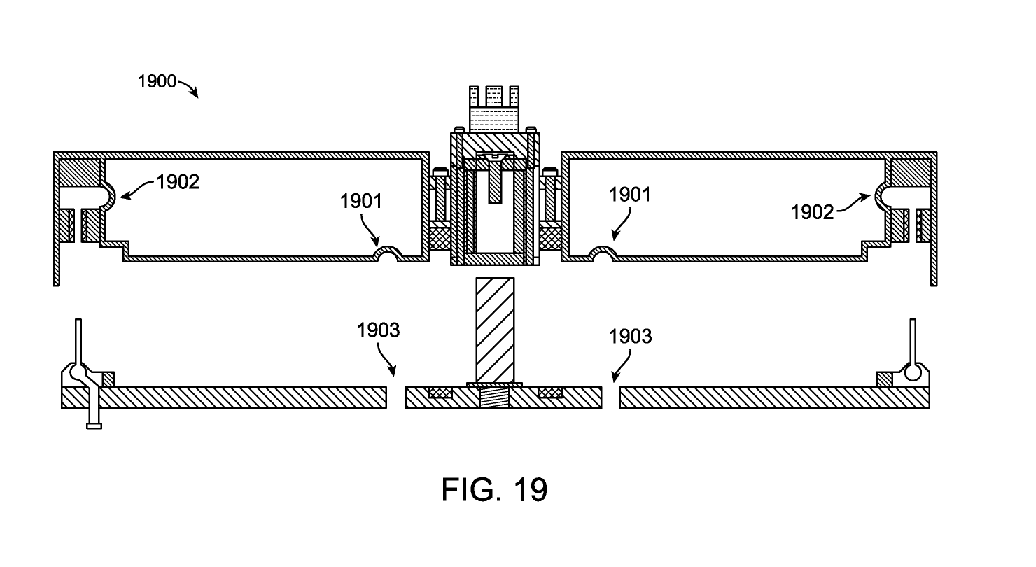

The embodiment of the present disclosure is illustrated in detail through FIGS. 1 to FIGS. 23. The generator of this invention creates electrical energy by rotating a magnetic field formed by permanent magnets, across a radial air-core set of coils. Mechanical energy, derived from wind from the movement of air masses passing over a turbine, moving of falling water, from a steam turbine, from combusting gasoline, and other forms of such kinetic and potential energy is directed to generate rotation along a shaft which is connected to a plate to form a rotor.

FIG. 1 shows a plan view of the rotor consisting of a circular base plate 101 made of aluminum, composite or other non-magnetic material. Rotational energy is applied to this rotatable element through the shaft 104 which terminates at this plate. The rotor contains a vertical outer 103 and inner 102 band separated by an air gap. This gap is formed between one set of magnets place along the outer surface of the inner band 102 and magnetically permeable material of the outer band 103 or the inner surface of the outer band 103 and magnetically permeable material of the inner band 102, or between sets of magnets placed along both of these surfaces. A radially oriented stator, slightly narrower than this gap, will eventually be inserted into this gap leaving a small air space on either side of the stator. Permanent magnets, such as ceramic, alnico, samarium cobalt (SmCo₅), or the very strong N50 grade (50 million Gauss Oersted) Neodymium Iron Boron (Nd₂Fe₁₄B) magnet which was utilized in one model of this invention, are utilized. These rectangular magnets FIG. 2A are placed vertically along its radial band, equally spaced around the band, with their magnetic polarity alternating. To insure that this alternating polarity is retained around the entire circumference of the rotor, the rotor circumference must be an even multiple of the width of each magnet plus its gap to the next magnet. The prototype 40″ diameter generator utilized 120 N50 magnets to generate 7500 KW of electric at 150 RPM.

Stronger magnets will allow more electrical energy to be generated than weaker ones. If desired, the rotor bands can be made taller and either longer or stronger magnets installed along the band, or a double or triple row of magnets FIG. 2B may be utilized.

The rotor is capable of moving freely by rotating on bearings 105 of FIG. 1. Strong permanent magnets 106 are placed into and through the rotor in vertical slots through an arrangement which allows the vertical height of these magnets to be adjusted up or down within these slots. The polarity of each of these individual magnets is set to be the same polarity as a magnet ring which is placed opposite these magnets in the stator. These magnets, by repelling the magnetic ring below it, will levitate the rotor allowing it to float nearly friction free on its bearings allowing less torque to be required to initiate rotation than without such magnetic levitation. There are 8 of these maglev magnets equally spaced around the rotor in the embodiment of this invention.

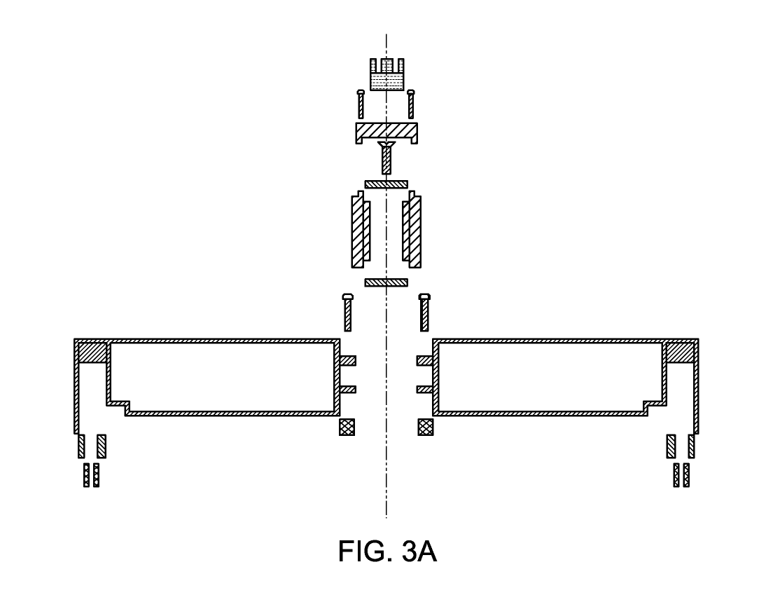

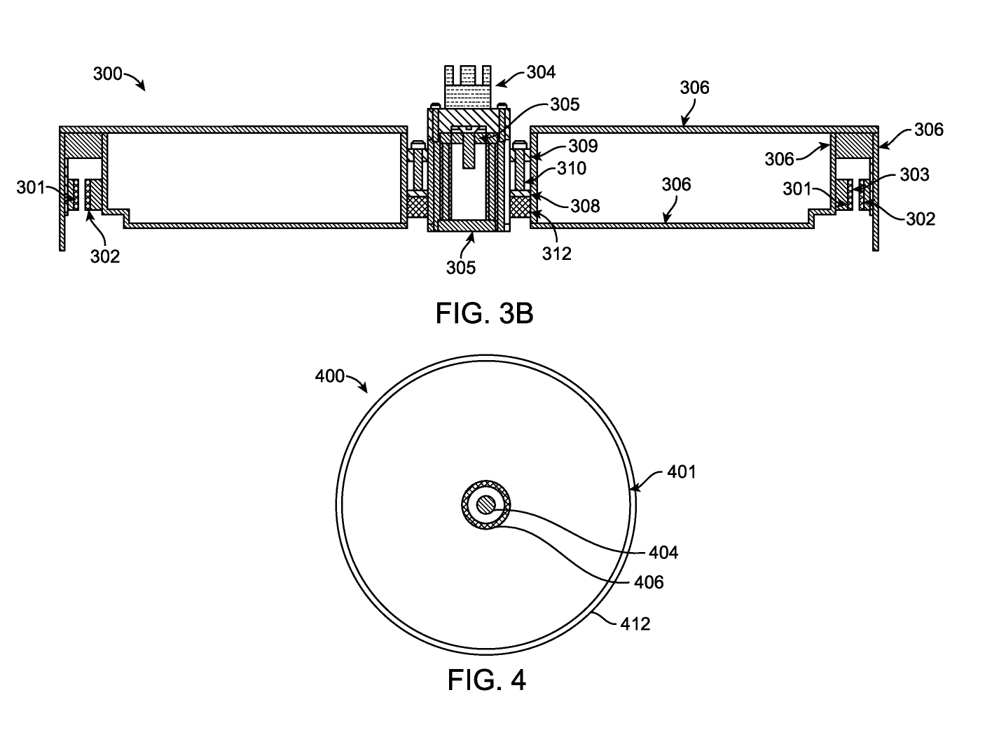

FIG. 3A shows an exploded front view of the rotor. FIG. 3B is an assembled view of the rotor and shows the slot arrangement that is used to adjust the height of the levitation magnets 312 in the rotor. Magnetic Levitation (maglev) adjustment screw 310 rests in maglev adjustment thread 309 which is physically attached to the body of the rotor. A polyethylene pad is placed between the adjustment screw and the maglev magnet to push down on the magnet. Turning the adjustment screw allows the maglev magnet to move vertically in the slot. During the assembly phase of the rotor above the stator, the opposing magnetic force of each of these maglev magnets will lift the rotor above the stator. The adjustment screws are turned to bring these magnets to a distance from the opposing magnet of the stator, to reduce the weight of the rotor on the bearings 305 to a desired degree. In a prototype of the generator a 200 pound rotor was reduced to the equivalent force on the bearings to that of a 1 pound rotor. The adjustment screws around the entire rotor are each adjusted to insure the rotor is floating perfectly parallel to the stator below it. The maglev force reduces the frictional forces on the bearings to a minimum which prolongs the lifespan of these bearings and allows the generator to operate for far longer periods of continuous operations than all generators prior to this invention. Maintenance associated with the replacement of internal motor bearing is nearly eliminated using these magnetic levitation forces. The near elimination of the friction that would have been associated with the full weight of the rotor on the bearings also allows more torque to be applied to the spinning of the rotor instead of to overcoming frictional forced. Since friction also causes the creation of heat, much heat that would have otherwise been created while the rotor spins on its bearings, is nearly eliminated.

A band or ring 302 is connected to the outer wall of the rotor. A similar ring 301 is connected to the inner wall of the rotor. These rings may be made of steel or of a composite material that is impregnated with iron filings. The iron impregnated composite allows for the creation of a lighter rotor which requires less inertia to start it rotating than its heavier steel counterpart. The use of a composite material allows for the creation of a mold to precisely cast such rings whereas the use of steel would require precise machining to close tolerances to insure uniform thickness and the precise circular ring shape. Casting these rings dramatically lowers the cost of creating the stator which is desirable when being able to sell small wind electric generation products for use at individual homes. Strong permanent magnets 303 are attached to the inner ring 301, the outer ring 302 or to both the inner and outer rings.

The entire rotor housing, 106 is made of aluminum, composite or other non-magnetic material.

Like the rotor rings, the entire housing can be cast from a mold to lighten the weight of the rotor and reduce the cost of producing the product. A shaft coupling 304, such as those manufactured by Lovejoy, brings the mechanical energy from the shaft connected to the source of the rotational energy, to the rotor housing.

The stator base plate 412 in FIG. 4 is made of aluminum, composite or other non-magnetic material. Like the rotor, the stator can be cast from a mold to lighten its weight and reduce its costs of production. It also allows for the precise alignment of the connection to the stator such that it will be properly aligned with the gap formed between the rotor rings when the entire generator is assembled. Cast pieces provide for precision manufacturing of the generator component parts without the expensive steps that would be required in machining non-magnetic aluminum or other metal parts. The compressed and potted coil loops 401, which will eventually be rotating inside the rotors magnetic field, are formed into a belt and are integrated into the stator plate to form a precise circular ring that is perfectly aligned with the rotor gap so as to be positioned inside the gap while still allowing for a small space on each side of the compressed coils and the rings of the rotor.

A magnetic ring 406 of the same polarity as the small magnetic disks mounted inside the rotor is embedded into the stator plate. The disk and the opposing magnets of the rotor will create the magnetic levitation that will eliminate friction on the bearings and nearly eliminate cogging of the generator. The central shaft 404 of the stator plate aligns the rotor above the stator. It is fitted into the bearing structure in the rotor.

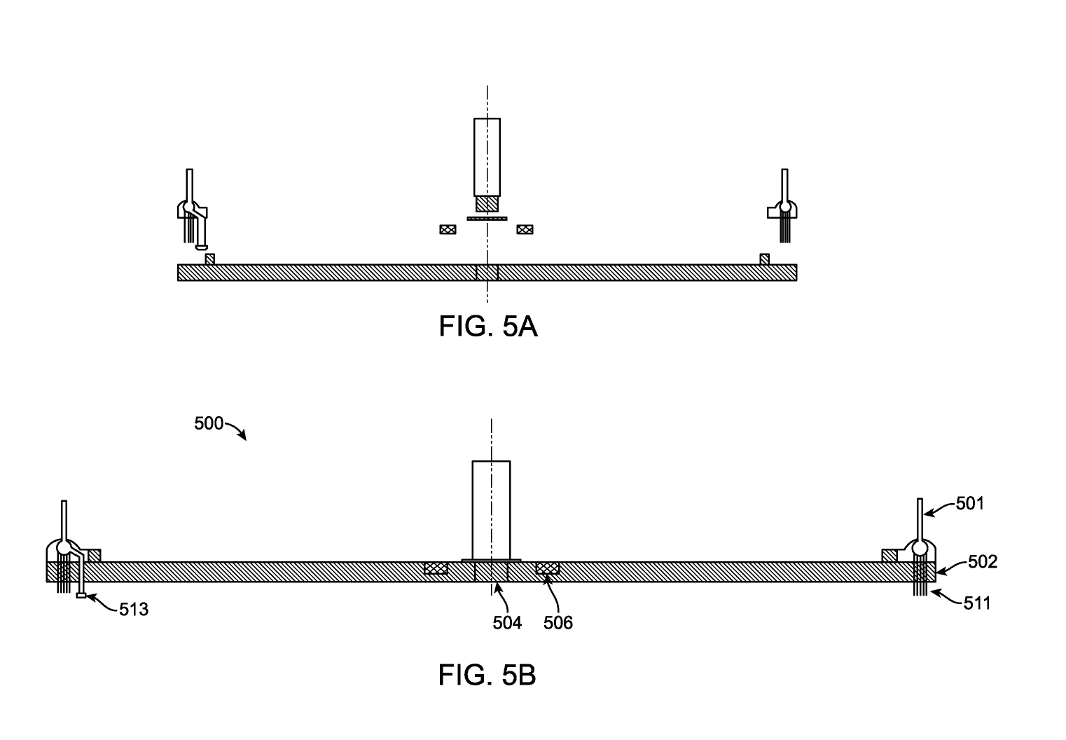

FIG. 5A shows an exploded view of the stator. FIG. 5B shows an assembled view of the stator and the magnetic ring 506 embedded in the stator plate 512. The rotor will eventually be placed over the alignment central shaft 504 which is screwed into the stator plate. The stator compressed coil ring 501 is mounted to the stator plate. Three pairs of wires 513 which will carry the three phases of generated electricity come out of the stator coils, through the stator plate and will go to external circuitry connected to distribution electronics to bring the generated power to where it will be utilized. Below and physically connected to the base of the stator coils throughout the entire stator ring, are heat sinks 511 to conduct and generated heat from the stator, through the stator base plate and out to the air below the stator. These heat sinks radiate the heat to the air. In another embodiment, a radiator mechanism is attached under the stator base plate and to these heat sinks to dissipate any generated heat more quickly.

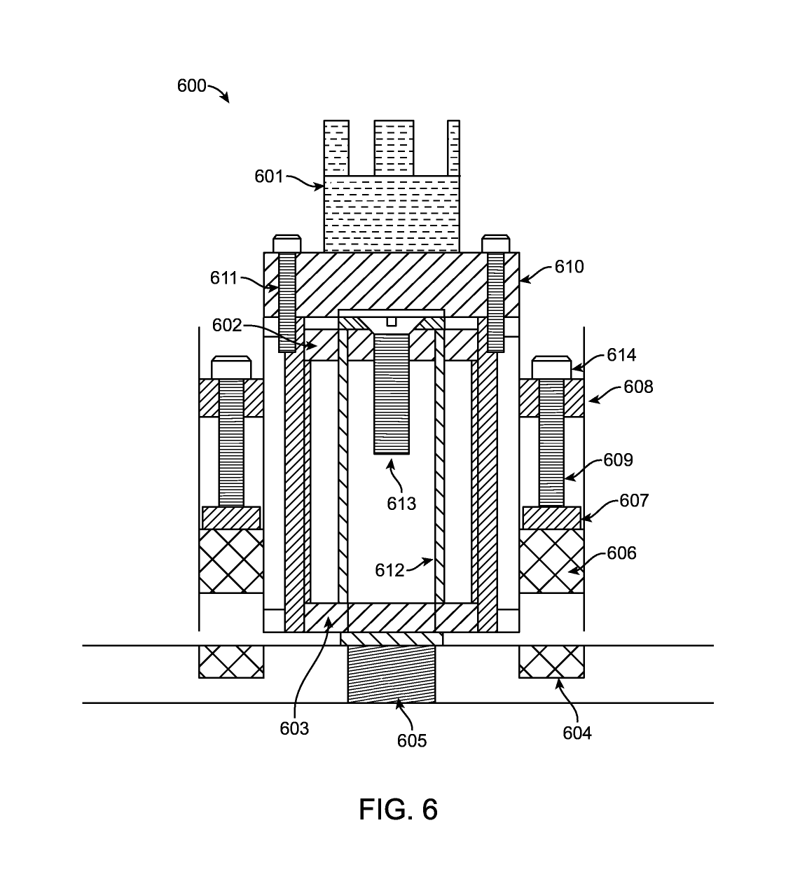

The center shaft 612 of the stator in FIG. 6 is threaded 605 into the stator base. A housing 610 containing an upper 602 and lower 603 set of bearings is held together through screws 611. The Lovejoy connector 601 brings the mechanical rotating energy into this rotor housing. This rotational mechanical energy transferred from the Lovejoy connector causes the entire housing and the rest of the rotor connected to it, to rotate. The magnet ring 604 embedded into the stator base causes the rotator housing to float above the ring dramatically reducing the weight of the rotor and allowing it to rotate on the bearings with little downward force and therefore little friction. Maglev adjustment thread 608 is both parts of the housing as well as an integral part of the rotor itself. The adjustment screw 614 which is connected to a polyethylene pad 617 glued to an individual magnet 616 of the same polarity as the magnetic ring, is turned in order to insure the rotor is perfectly parallel to the stator and that there is minimum rotor weight on the bearings. There are 8 maglev magnets equally spaced around the rotor in the embodiment of this invention.

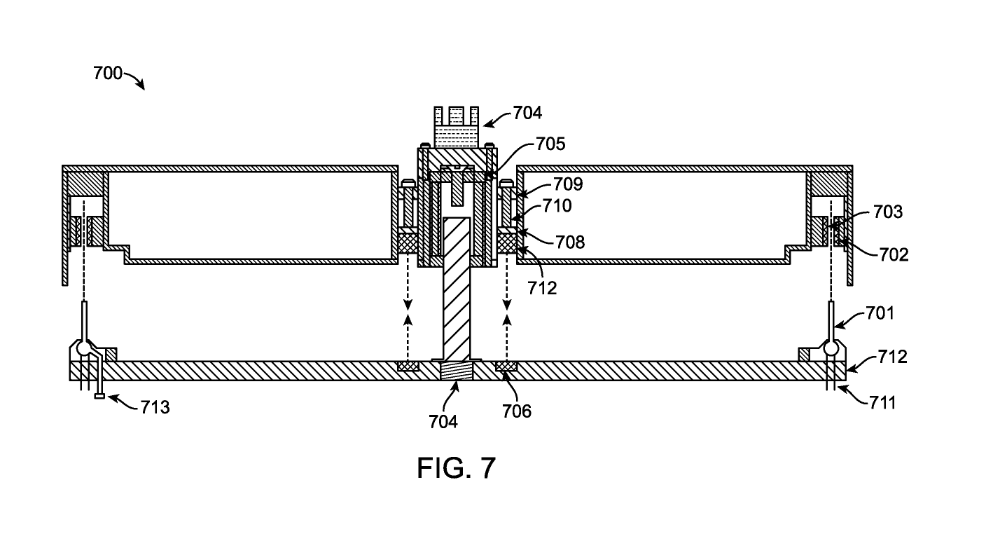

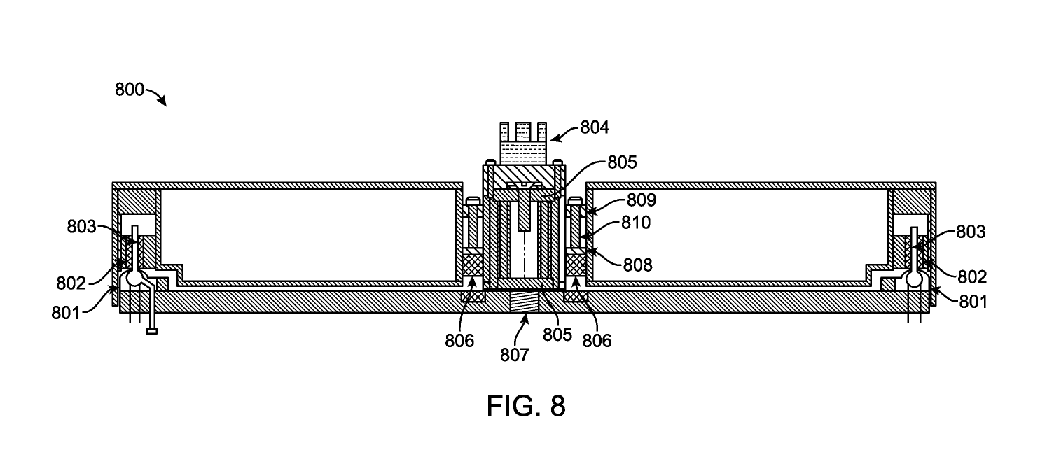

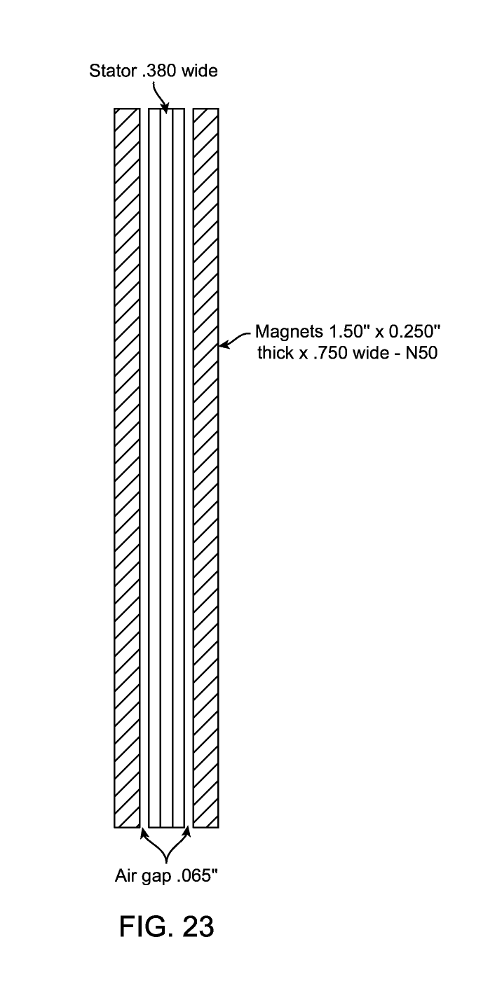

The rotor, through its rotor housing, is aligned with the stator shaft 704 and placed over the stator as shown in FIG. 7. The maglev magnets 712 cause the rotor to repel the magnetic ring 706 embedded in the stator plate. The adjustment screws insure that the height, at which the rotor floats above the stator through this levitation, insures that the stator coils 701 are perfectly aligned so that the rotor magnets 703 are vertically aligned with vertical center of the rotor. This alignment is further shown in FIG. 8 where the rotor is fully in place. When fully aligned, because of the precision shape of the stator coil 801 and the rotor gap between the ring or magnets 802 and magnets 803 in the rotor, a uniform air gap is created on either side of the rotor coils. Tolerances in manufacturing insure that this gap remains uniform as the rotor spins around the stator coils. FIG. 23 shows the thickness of the stator, size of the magnetics and the tolerances that were used in the prototype generator. The rotor assembly will be dropped down over the stator so its magnets are separated from the stator coils by a small air gap.

The spinning rotor causes the magnetic lines of force of each magnet to pass through the coils embedded in the potted rotor. This changing magnetic field generates an electric field in the coils thus driving electric current in the coil. The amount of current generated is based many different factors. Some of the most important are which: the amount of conductive wire being utilized in both cross section and length, the geometry of the coils, the number of coils, the number of loops in each coil, the strength of the magnetic field, the speed at which the magnets are passed over the coils, and the available torque to rotate the magnets through the coils. By adjusting these various factors, one can determine the set of parameters that will result in a generator capable of producing a desired level of power at the average RPMs that is expected to be provided through the incoming rotational mechanical energy.

The key to calculating how much energy the generator will potentially produce is to first determine the magnetic flux density B, measured in Teslas (T). One Tesla is equal to 1 Weber/m2 where Weber corresponds to magnet flux which is essentially the quantity of magnetic field that penetrates an area at right angles to it. The value of B used in the power calculations is not the density at the surface of the magnet itself, but the density that the coils will see as it passes through the magnets. The determination of this density is a complex process that is very much dependent on not only the geometry of the individual magnets being used in the generator, but also their placement next to each other and the distance over the gap to where the stator coils are located. Flux density drop quickly from the surface of a magnet but changes if magnets are facing each other, if other magnets are next to it and depending upon how close they are, the material, thickness, lengths, etc. When magnets are close they can strengthen each other, if magnet are too close their field could go into the neighboring magnet instead of across the gap and through the stator coils. So layout of the magnets along the rotor is extremely important. The magnetic flux density is primarily calculated using Finite Element Analysis. A program called FEMM (Finite Element Method Magnetics) is a program capable of analyzing magnetic factors to determine the flux density as well as providing a graphical representation of the field lines of a magnetic configuration showing how the flux density changes at different points around the configuration. Using FEMM, the average flux density at the stator coils can be determined.

Once the average magnetic flux density B is determined, the product of B x (the number of magnets being used) x (the area of each magnet in m²) provides the value of the change in flux in the movement of one loop of wire passing by one of the magnets in the rotor. Multiplying by the number of coils wound in the stator, we determine the total open circuit voltage generated for the multiple wire loops in each coil for the movement across one magnet and multiplying by the number of magnets provides the total open circuit voltage per rotation. From this, we know the open circuit voltage generated per phase for any given RPM. In the three phase system of this embodiment, the voltage generated in each phase is three sine waves each 120° apart from each other. The total steady voltage that can be generated for a phase is determined by imagining three vectors 120° apart rotating around the same origin each of whose length is equal to the voltage at a point in one cycle. Calculating the distance between the points of these vectors will be the square root of 3 times the length of the vector. So the actual voltage generated is the open circuit voltage for one phase times the square root of three. The total shorted power of the generator, which occurs when there is no load on the generator, is given by V²/R where R is the total resistance of the stator and load resistance equals zero. This resistance is calculated by knowing the total length of the wire in the stator (for all loops) and knowing the resistance per foot of wire. Multiplying this shorted power per phase by three for the three phases, results in the total shorted power (or maximum power) that the generator is capable of producing. It is easily shown that the maximum power that can be delivered to a load is at the point when the stator resistance equals the load resistance. At this point the generator is 50% efficient and is delivering 25% of the maximum possible power to the load. So using these figures one can determine the useful power that the generator will deliver against a load.

In practice the actual available power delivered is a percentage of the maximum theoretical power under load. Depending upon the efficiency of the generator, a percentage of this useful power is actually realized. One can modify the number of coils, number of magnets, gauge of the wire (and thus its resistance), and these other parameters against the expected average RPMs to determine the set of parameters that will be utilized to produce the derived expected power level.

Adjusting many of the parameters of the generator components has a multiplying effect on its generating capabilities. Voltage per RPM increases by N for each N additional coil loops added to the rotor and by N for N additional magnets added to the rotor. This is an N² increase in voltage. Of course resistance will be increased due to the additional wire but this increase is N times the prior resistance. Since the total effect on power is given by V²/R, the actual power increase in this case is (N²)²/N or N³. So doubling the number of magnets in the generator and the number of coils will increase the power of a generator by 8 times (2³). Of course this will make the generator physically larger to incorporate the additional magnets around its circumference and the additional thickness of the stator, but the cogless nature of the generator, makes it easy to drive large diameter generators.

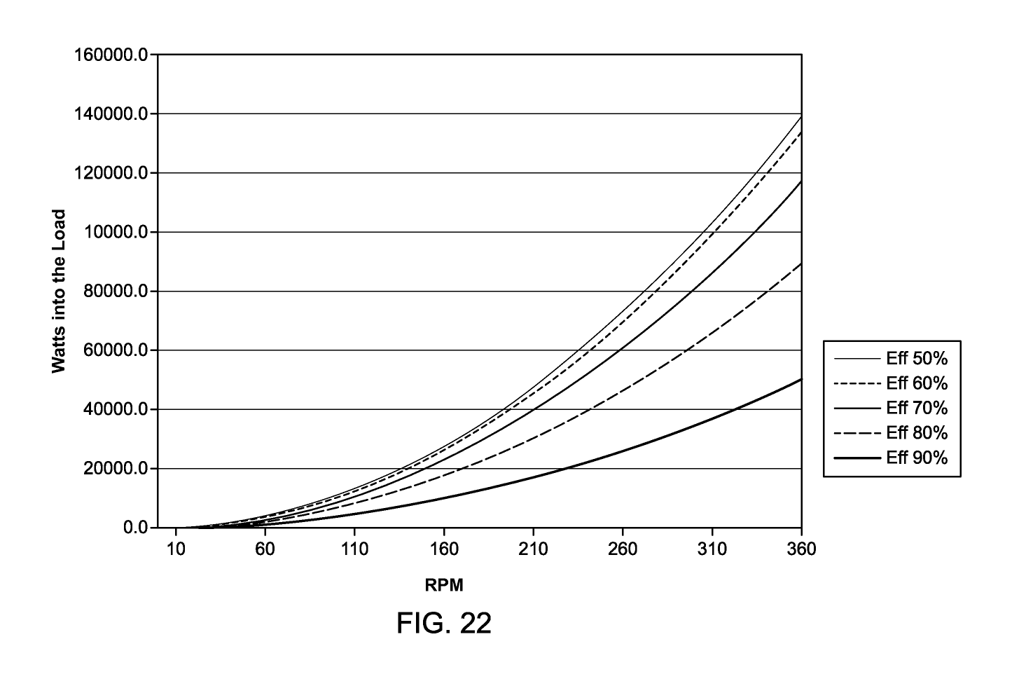

Depending upon what load is being driven by the generator will determine the efficiency at which it will operate. If a low resistance load is driven by a high resistance generator, then the windings of the generator will retain more of the generated power than the useful energy it can output and the result of this energy will be to heat up the stator coils. To maintain the highest level of efficiency of the generator an intelligent external control unit is used to match external loads to the capability of the generator so that the stator will not absorb excess energy and heat up. In the embodiment of this invention, an intelligent Maximum Power Point Tracking (MPPT) control device was developed which insures that a wind turbine is operating at an optimal RPM rate to extract the most mechanical energy out of the turbine while at the same time insures that the generator is under a proper load to maintain its operation at the highest level of efficiency. FIG. 22 shows a graph of how the doubling of the number of coils and number of magnets in the generator will increase its output power. The various curves represent this increased power depending upon the efficiency of the generator. The MPPT allows the higher efficiency levels to be achieved.

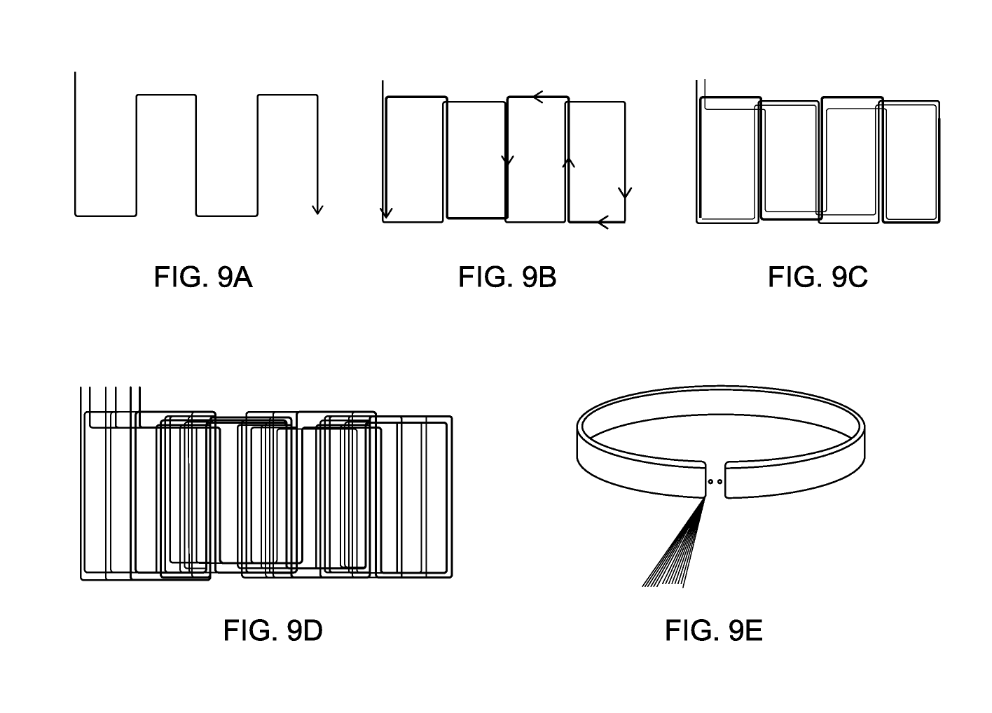

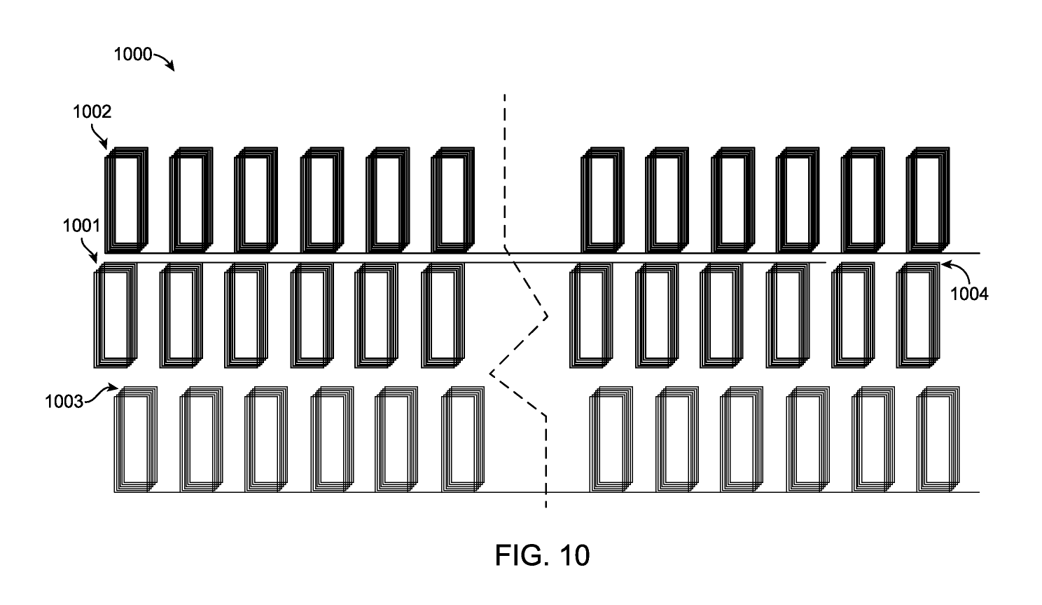

The stator construction is designed to create a dense core of copper wire without the typical iron core found in generators. The replacement of an iron core with an air core eliminates the magnetic attraction of the stator to the rotor magnets allowing the rotor to turn with very low torque since it does not have to overcome magnetic forces which would normally try to keep the rotor locked in place. FIG. 9A through FIG. 9E shows the steps involved in the creation of the dense stator core. Solid or stranded insulated wire is utilized in the core. A special jig is used to precisely wire the core. This jig insures that the wire loops which will be created are of a uniform size and shape and form a series of rounded rectangular coil loops when fully assembled. The length of the jig is equal to the circumference of the final stator belt that will be formed from the coil loops. FIG. 9A shows how the wire is first wound into the half-loop shape. The wire runs in this down and up pattern shown in the figure, from the starting point in the rig to the end of the rig located at a distance from the start equal to the stator circumference. Once reaching the end of the rig, the wire is wound across the bottom of the last half-loop, and is then wound in an up and down pattern, as shown in FIG. 9B, to form a series of completed rounded rectangular loops. This winding pattern continues until the wire reaches the starting point where the winding first began. This sequence is followed a second time, as shown in FIG. 9C, to form loops which now contain loops consisting of two wires. The pattern is repeated as many times as has been determined to leave the desired amount of copper in the core based on the amount of power that the generator has been designed to deliver. This sequence creates the coil belt which will generate one-phase of the electric current generated.

This same sequence is carried out two more times to create three separate sets of coil belts. The jig on which the coils are wound, is designed in such a way as to lay out each coil loop in a manner which precisely stacks each loop of the coil on top of each other with a slight offset in each loop created. The offsets of the coils of one of the three belts is made such that the three sets of coil belts can be laid on top of each other but offset one-third of a loop from each other as shown in FIG. 9D. Since the wire from all three belts started their wiring windings from the same position and are all ended at that starting position, the three pair of stator wires for the three phases are all at the same position.

This belt glued together in a few key locations to keep the three sets of coils in place as they are now assembled into a ring shape shown in FIG. 9E. The three sets of coils are slightly offset from each other and then placed on top of each other as shown in FIG. 10, to form the dense coil core. Coil 1002 is placed over coil 1001 and coil 1003 is placed on top of those coils to form the single belt. The manner in which each loop of each coil is wound, allows the coils to easily fit inside of each other. One a single belt is assembled it is placed into a ring shape so that point 1001 and point 1004 meet to form the ring.

The coil winding method insures that the three coils that are assembled will fit into each other.

The coils are hydraulically pressed against each other to form the belt into a dense core. Such a dense core allows a lot of copper to be placed into the rotor gap and very close to the strong magnetic flux of the rotor magnets. This provides for an increased generation of electricity than traditional generators.

Heat conducting rods are inserted through the stator plate under the location where the stator coils will eventually be placed. The top of the rod is flush with the stator plate so that when the stator coils are placed onto the stator plate, the bottom of the coil will come in physical contact with these heat conducting rods. These rods will carry heat generated during the electric generation, out through the stator plate to the air or a radiator below the stator plate. Once the rods are set in place, a casting mold which has been created in the precise shape to fit into the gap of the rotor is placed onto the stator plate. Teflon sheeting are placed inside the mold and held in place with tape along the exterior walls of the mold. The Teflon tape covers the vertical walls but not the bottom of the mold. The stator coil weaving is wrapped with a layer of 4 mil fiberglass cloth and is inserted into the mold. There is a hole in the stator plate for the three pairs of wires to go through and below the stator plate. During the first phase of the assembly process of the stator ring, bolts that hold the casting mold together are loose. Once the stator coils are positioned correctly all the mold bolts are tightened securely to firmly compress the coils into each other to form a nearly solid copper block consisting of the three phases of wires. In a 40″ diameter prototype generator of this invention, each of the individual coils around the circumference of the stator consisted of 16 loops of wire. When all three phases were placed on top of each other and slightly offset to for the three 120° phases, the stator wires were 1″ thick. Upon compression and the potting in the epoxy resin, the resultant stator belt was reduced to ⅜″ thick. This compression step creates the extremely dense nearly solid cooper stator belt.

The exit hole for the stator wires is sealed with putty. The mold is set on a level surface and a liquid mixture of slow curing epoxy is mixed. The epoxy resin can either be sucked into the mold through a vacuum or can be poured in the top of the casting and agitated to insure there are no voids in the epoxy. It takes about 18 hours for the epoxy to gel and for any bubbles to work themselves out through the top. After approximately 24 hours of curing time, the mold is opened and the stator coils are encased in solid epoxy. The epoxy also encases the top of the heat conducting rods which are now an integral part of the stator coil assembly. In another embodiment before the heat sinks are inserted and the epoxy resin is poured into the mold, a rectangular groove is cut around the circumference of the stator plate just below where the stator coil will be placed. When the epoxy resin is poured into the mold it also fills the groove in the stator plate and allows the stator to more securely adhere to the stator plate.

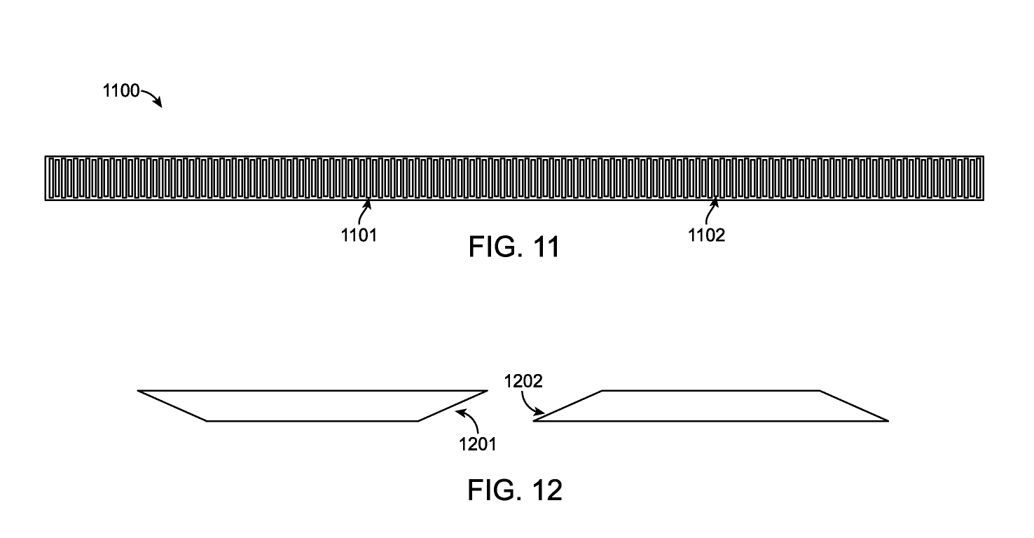

FIG. 11 shows the rig used to assemble the three wire belts. Such a rig is created for each size generator that is constructed. The length of the rig is equal to the circumference of the stator belt that is created to fit inside the gap in the rotor. The rigging consists of a series of removable trapezoidal pegs that can be placed into holes in the linear rig. There are longer holes 1101 and shorter holes 1102 in the rig. The pegs which fit into the longer holes are used to weave two of the three coils of the rotor. The pegs which fit in the smaller hole is used in the weaving of the third coil. The shape of the peg which fits into the small hole is shown in FIG. 12 as 1201 and the peg which fits into the large hole is 1202. One coil belt is woven at a time. The shorter pegs are inserted along the rig only and the weaving process down and up across the pegs proceeds from the leftmost side of the rig to the rightmost side. When the first set of loops are now created by weaving the wire up and down across these same pegs, the wire is placed slightly above the first layer of wire put down, by placing that layer of wire adjacent to the first layer and a little higher up on the trapezoidal peg. When the wire is woven a second time across the rig to create the second loop of each coil, once again each row across the rig is placed adjacent to the prior rows and just a bit higher on the trapezoidal peg. The wire coils are glued together in a few key points to hold them together and the pegs removed so that the coil belt can be removed from the rig. Two sets of coils are woven in this fashion.

The short pegs are removed and the longer pegs are inserted and the same weaving process is completed for the third coil. The location of the equal size pegs along the rig is set so as to create the wire loops of the precise rounded rectangular size desired. Once the three coils have been created, because of the skewed shape of the first two coils created and the reversed skewed shaped of the third coil created, the third coil will exactly fit into the two coils placed on either side of it. The skewed outer coils exactly mesh with the reversed skew of the inner coils to form the dense set of three coils which will generate the three-phased current when the magnets are passed around the coil. Because of the way the outer weavings fit on either side of the inner weaving, a stator of uniform thickness is created. Once sealed in epoxy resin stator is perfectly circular of uniform thickness all around and concentric to the rotor gap allowing the rotor to spin freely above the stator without touching the inner or outer walls of the rotors rings.

Although the steps described shows how three coils are used to assemble the dense stator coil ring, similar steps could be taken to assemble more sets of coils slightly offset from each other. This would create a generator that could generate four, five or more phases of electric at the same time. With the three coils set off by one third of the width of a coil, alternating current offset at 120° from each other is generated. Four coils offset by 25% of the width of a coil would generate output in each phase 90% off from each other.

The unique stator winding arrangement of this invention allows multiple phases of wires to essentially fit into each other instead of being stacked on top of each other as in prior generators. Room normally left for wire loops to stack over each other at crossings, which makes the stator thicker, is reduced or eliminated allowing more wire to be placed into a stator than before. More wire in a given thickness of stator will generate more electricity than a stator not as dense as that which is created in this invention. In addition, due to the compression step prior to potting the stator in resin, even more wire loops can be built into the stator prior to the compression step. The compressed dense stator core that results from the assembly process becomes nearly a solid copper core which maximizes the electrical generation properties.

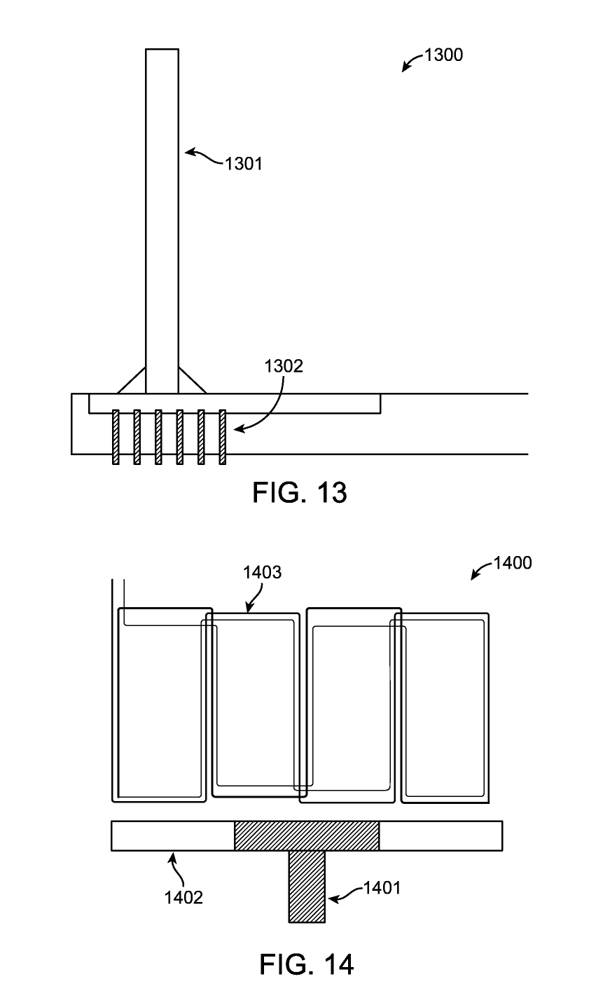

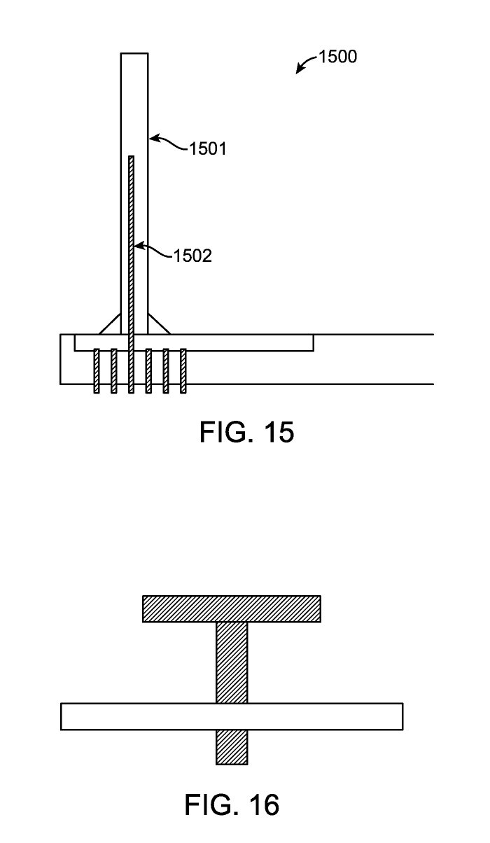

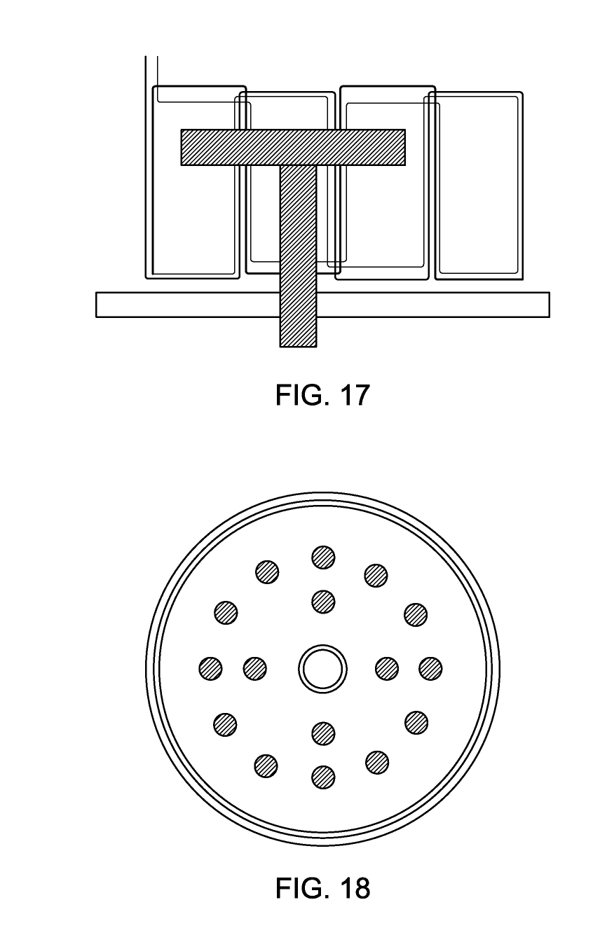

Before the assembled stator belt 1301 of FIG. 13 is placed on the stator plate for the application of the epoxy resin, heat conducting rods 1302 are first placed in small holes that have been drilled through the stator plate. A straight heat conducting rods may be placed into each hole and held into place with heat conducting resin. In other embodiments as in FIG. 14, a T shaped heat conducting rod 1401 is put into each hole where a grove has been machined or molded into the stator base pate so that the top of this T is flush with the top of the stator plate 1402. The T shaped heat conductor provides additional surface area for heat from the stator coils 1403 to dissipate through the heat conductor and out through the bottom of the stator plate. In another embodiment, shown in FIG. 15, at the cost of a little thicker stator 1501, a heat conducting rod 1502 may be placed inside the stator before the epoxy resin is applied so that it becomes an integral part of the stator. This T shaped rod extends through the stator plate as in FIG. 16. The resultant combination shown in FIG. 17 has a larger surface area across the stator coils to transfer heat to the air space below the stator plate where is can be dissipated or attached to a radiator to remove the heat.

While the rotor is spinning, air inside the generator will be heated from the energy being generated in the stator. Because of venting arrangements integrated into the rotor, this air moves out from the generator around its circumference from the air gap between the rotor and stator. In some embodiments, to provide additional heat transfer for the air inside of the generator, additional heat sink rods or T-shaped heat sinks can be placed around the bottom plate of the stator as shown in the example of FIG. 18. These heat sinks come in contact with the warm air inside the generator and allow this heat to also be dissipated into the air below the stator.

The rotor is designed so as to drive the air inside of the generator out of the sides of the generator as the rotor is spinning. Air leaves the generator in the space between the rotor air gaps and the stator coil assembly. Air scoops help direct the air flow through the generator. The scoops are holes 1901 and 1902 cut into the rotor by drilling at a 45° angle through the thickness of the bottom and side of the rotor, so that the leading edge of the drill holes face the direction of the rotors rotation. In some embodiments, to further enhance the air flow, mounted to the inside surface of these air holes are channels which further direct the air flow through the interior of the rotor. Air enters the assembly through air intake holes 1903 that are cut into the stator. In other embodiments these air intake hole can be cut into the top of the rotor instead of the stator or be placed in both the rotor and the stator. The advantage of the holes in the stator is that holes in the rotor could result in dirt or dust falling from above the generator falling into the rotor. To prevent this in such embodiments, shielded air scoops that bring in air from the direction of rotation can surround the air intakes so that air enters from the side of the scoop but falling debris will not enter the rotor.

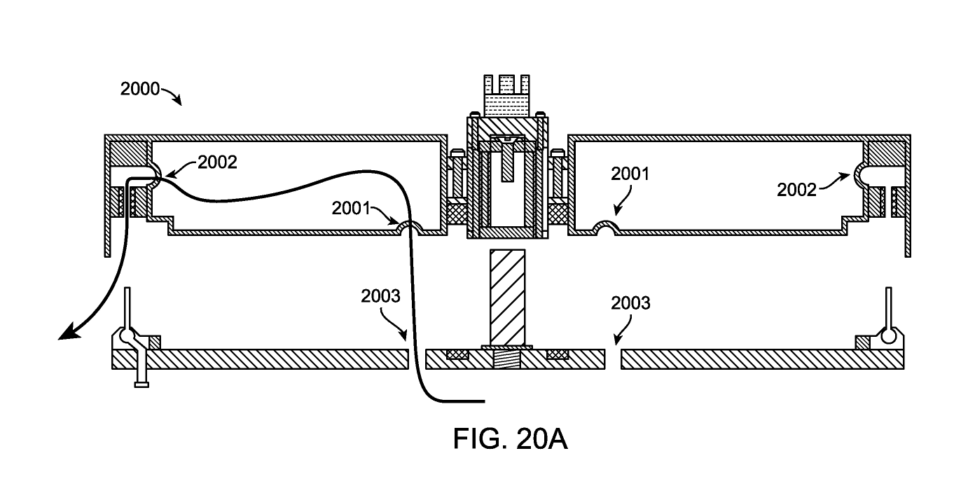

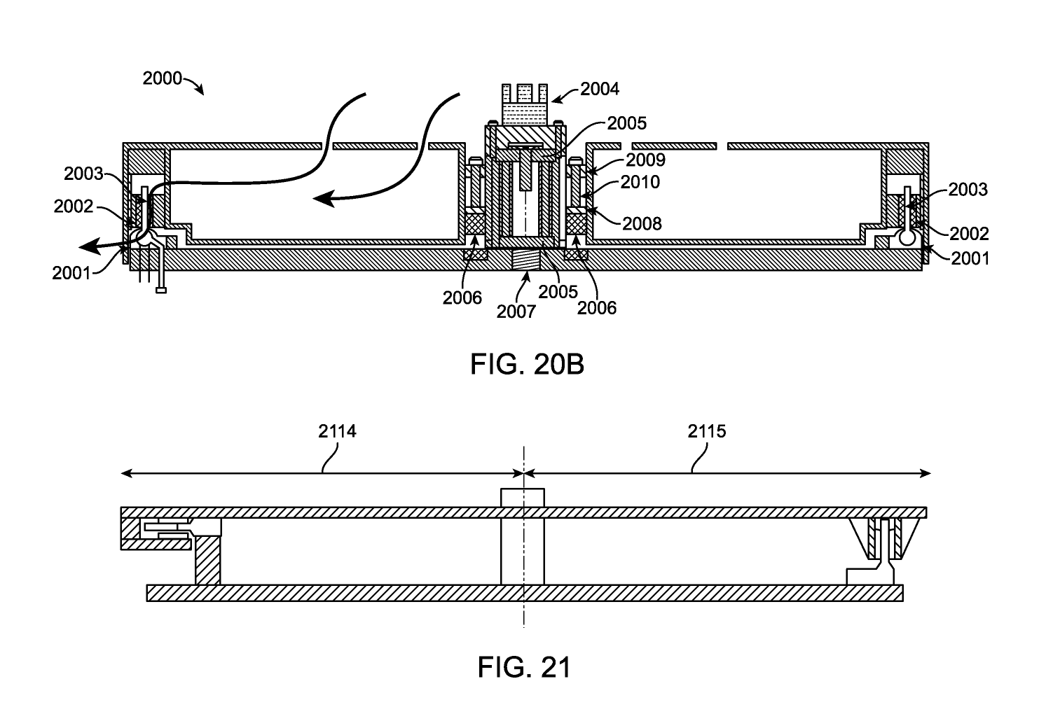

FIG. 20A shows the air flow through this invention when it is in operation. Air enters through the intakes, flows through the interior of the rotor, and is forced out around the entire circumference of the generator in the air gap around the stator. FIG. 20B shows the air flow in an alternate embodiment where the air intakes are cut into the top of the rotor.

Testing of the prototype generator showed that there was no appreciable rise in the temperature of the air leaving the generator over the 46 power generation runs that were conducted. The power in each run was used to drive a resistive heater to raise the temperature of a fixed amount of water for each run. During the testing runs the water temperature rose as much as 35° C. while the air temperature from the generator never varied more than 4° C.

Although this invention has described the stator assembly as being placed near the outer circumference of the stator plate, this is not the only orientation that is possible. FIG. 21 shows two different orientations of the stator coils that could exist. 2115 shows the arrangement of the stator coils in the invention described. 2114 shows an alternate stator coil configuration that could exist in another embodiment of the invention. In 2114 the stator coils are placed parallel to the stator base plate as opposed the perpendicular arrangement already described. The gap in the rotor and the magnets on one or both sides of this gap is also parallel to the base of the stator base plate and form a circular ring around the rotor. This arrangement will also generate electric in the same manner as the invention already described. The difference between the vertical stator arrangement and the horizontal stator arrangement is that the vertical arrangement is more tolerant of wear, misalignment and vibration issues and reduces the potential of the rotor contacting the stator coils. Of course in one embodiment of the invention, either arrangement 2114 will be used or 2115 will be used and not both at the same time.

Because the non-cogging generator of this invention needs little torque to start it rotating, given the elimination of magnetic attraction to the stator core and the dramatically reduced friction on the bearings, it is easy to turn the rotor. The diameter of stator plate and rotor can be made very wide so that the stator coils are far from the center shaft. A wide stator allows a slow RPM to translate into a longer arc distance that the stator must travel to make one complete rotation as compared to a stator that was close to the center shaft since the circumference equals 2π×the radius. The longer circumference also allows more magnets to be placed into the rotor. The non-cogging generator only needs to overcome the inertial forces to start the rotor spinning to begin its rotation. This increased radius to the stator over typical generators, which can now be supported due to the elimination of cogging, allows a low RPM to move the magnets more rapidly across the stator coil. This increases the generated electric current over a narrower size generator.

Numerous modifications and variations of the described preferred embodiment are possible and will occur to those skilled in the art in light of this disclosure of the invention. Accordingly, I intend that these modifications and variations, and the equivalents thereof, be included within the spirit and scope of the invention as defined in the following claims.

I claim:

1. A cogless electric generator to convert rotational mechanical energy to electrical energy consisting of a bearing supported rotor turning around a central axis such rotor containing a plurality of magnets whose rotating flux crosses a small air gap to a fixed stator containing a compressed densely pack belt-like structure containing a plurality of wire coils potted and encased in a resin to form a non-magnetic core, generating electricity as the magnetic flux crosses the stator coils, such stator core in physical contact with heat sinks which extend out of the stator assembly to dissipate heat.

2. The cogless electric generator of claim 1 in which a magnet structure placed into the rotor is aligned A cogless electric generator to convert rotational mechanical energy to electrical energy consisting of a bearing supported rotor turning around a central axis such rotor containing a plurality of magnets whose rotating flux crosses a small air gap to a fixed stator containing a compressed densely pack belt-like structure containing a plurality of wire coils potted and encased in a resin to form a non-magnetic core, generating electricity as the magnetic flux crosses the stator coils, such stator core in physical contact with heat sinks which extend out of the stator assembly to dissipate heat to magnetically oppose a magnetic structure fixed in the stator so as to levitate the rotor above the stator and nearly eliminate the weight and friction on the bearings.

3. The stator of claim 1 in which each row of each wire loop in the stator is stacked just slightly offset from the prior row.

4. The stator of claim 3 in which multiple sets of belt-like coils are placed on top of each other and offset by 360 degrees divided by the number of belts, such belts fitting into each other due to the stacking and compressed to form a very dense stator.

5. The stator of claim 4 in which three sets of coils are placed 120 degrees apart to generate three phase electricity.

6. The cogless electric generator of claim 1 in which air holes are placed in the rotor causing a flow of air between the rotor and the air surrounding the air gap between the magnets and the rotor.

7. The cogless electric generator of claim 1 in which air holes are placed in the stator causing a flow of air between the stator and the air surrounding the gap between the magnets and the stator.

8. The cogless electric generator of claim 1 in which the heat sinks in physical contact with the stator dissipate heat into the air.

9. The cogless electric generator of claim 1 in which the heat sinks in physical contact with the stator dissipate heat into a radiator type structure to remove the heat from the generator.

10. The cogless electric generator of claim 1 in which heat sinks extended from the interior surface of the stator and out of the stator and are not in physical contact with the stator core.

11. The cogless generator of clam 1 in which cooling channels are embedded into the base of the stator to allow a coolant to run through the stator to reduce heat.

12. The cogless generator of claim 1 where the stator is cast from an epoxy resin or polymer.

13. The cogless generator of claim 1 where the rotor is cast from an epoxy resin or polymer.

14. A low maintenance cogless electric generator having no magnetic attraction or repulsion between the rotor and the stator.

15. A cogless electric generator utilizing magnetic levitation to reduce the friction that a rotor will experience when rotating on bearings supporting it.

16. The stator of claim 8 in which the heat sink is embedded with the stator coils and extends out of the stator.

17. A method of winding stator coils so that they may be compressed and densely packed to provide a maximum amount of wire in a stator, such method creating a belt of stacked rounded rectangular coils where each loop is slightly offset from the prior loop so that multiple belts fit into each other to minimize the overall thickness of the combined belt.

18. The cogless generator of claim 1 in which a computer controlled lubrication system delivers lubrication material to bearing as determined by sensors that can monitor the wear on the bearings or the amount of lubrication material still around the bearings.

19. A cogless electric generator to convert rotational mechanical energy to electrical energy consisting of a bearing supported rotor utilizing magnetic levitation to reduce friction on the bearings, turning around a central axis, such rotor containing a plurality of magnets whose rotating flux crosses a small air gap to a fixed stator containing a compressed densely pack belt-like structure containing a plurality of wire coils potted and encased in a resin to form a non-magnetic core, generating electricity as the magnetic flux crosses the stator coils, such stator core in physical contact with heat sinks which extend out of the stator assembly to dissipate heat.
